(19) United States
(12) Patent Application Publication
(10) Pub. No.: US 2011/0273621 A1
(43) Pub. Date: Nov. 10, 2011

(54) Method of and apparatus for processing image data

(76) Inventors: Iain Richardson, Aberdeen (GB); Laura Joy Muir, Alford (GB); Abharana Bhat, Aberdeen (GB); Ying Zhong, Cambridgeshire (GB); Kang Shan, Cambridgeshire (GB)

(21) Appl. No.: 12/303,977

(22) PCT Filed: Jun. 15, 2007
(86) PCT No.: PCT/GB07/02234

§ 371 Date: Jun. 30, 2011

(30) Foreign Application Priority Data
Jun. 16, 2006 (GB) 0611969.7

(51) Int. Cl. H04N 5/21

(52) U.S. Cl. 348/608; 348/E05.077

(57) ABSTRACT

The invention relates to a method (10) of processing image data corresponding to an image to be viewed by a viewer. The method comprises identifying at least one part of the image (16), the identified at least one part being of interest to the viewer. The method also comprises filtering the image data with a bilateral filter (22), the filtering being selective in dependence on the identified at least one part of the image.

### FIELD OF THE INVENTION

The invention relates to a method of and apparatus for processing image data. The invention also relates in particular but not exclusively to video processing apparatus and video encoder apparatus using such a method of and apparatus for processing image data.

### BACKGROUND TO THE INVENTION

Low bit-rate real time video streams (below around 200 kbits/s) are often characterised by low-resolution, low frame-rates and blocky images. These characteristics normally arise because video encoders reduce the quality of the video content to match the available bandwidth.

The spatial resolution of the human visual system is highest around the point of gaze (i.e. fixation) and/or attention and decreases rapidly with increasing eccentricity. As a result, areas in a video stream are encoded at a higher quality than is needed because these areas fall outside the areas of fixation or attention. Conversely, areas of fixation or attention may be encoded at a quality that is below a deemed acceptable level of resolution of the human visual system.

It is known to apply what is termed content-prioritised video coding to video streams. Content-prioritised video coding involves improving the subjective quality of low bitrate video sequences by coding parts of the video stream that are of interest to a viewer at a high quality compared to other parts of the video stream. Content-prioritised video coding has been applied in visual communication apparatus, such as sign language communication systems, videophones, surveillance apparatus and in teleconferencing. A technique employed in content prioritised video coding is to process video frames of a video stream such that the video frames have a spatial resolution that matches the space-variant resolution of the human visual system; such a technique is often termed foveation.

The present inventor has appreciated shortcomings of the above described approaches to processing a video stream to provide for efficient use of limited channel bandwidth whilst providing for an acceptable level of quality for the viewer of the video stream.

It is therefore an aim for the present invention to provide a method of processing image data corresponding to an image to be viewed by a viewer.

It is a further aim for the present invention to provide for an apparatus for processing image data corresponding to an image to be viewed by a viewer.

### STATEMENT OF INVENTION

The present invention has been devised in the light of the inventors' appreciation of the shortcoming of known approaches. Thus, according to a first aspect of the present invention, there is provided a method of processing image data corresponding to an image to be viewed by a viewer, the method comprising:
identifying at least one part of the image, the identified at least one part being of interest to the viewer; and
filtering the image data with a bilateral filter, the filtering being selective in dependence on the identified at least one part of the image.

In use, the method is used to identify at least one part of the image that is of interest to a viewer. The identified at least one part might, for example, be a face of a person in the image, which is more likely to be of interest to the viewer than a background to the face or the rest of the person in the image. The image data is filtered in dependence on the identified at least one part of the image, such as the face of the person. Thus, filtering of the image data may differ from one part to another across the image.

An advantage is that the present invention can be used with standard video encoders and standard video encoding formats. Such backward compatibility of the present invention with standard encoders and encoding formats contrasts with known approaches of developing more sophisticated encoders that compress video stream data on a spatially variable basis.

Furthermore, the use of a bilateral filter according to the present invention offers advantages over known approaches to image data processing which rely on foveation. Foveation is typically applied in dependence on where a viewer directs his gaze or where a viewer is expected to direct his gaze. The present invention involves processing image data in dependence on a part of the image that is of interest to the viewer. Such a part of the image need not be where the viewer directs his gaze but may be a part of the image, such as a person's face, that is of interest to the viewer in terms of visual information conveyed by that part of the image to the viewer. Thus, the step according to the invention of identifying at least one part of the image may be content led rather than being led by where the viewer directs his gaze. In other words, the present invention may relate to what the viewer perceives from an image rather than what he merely sees in an image. The bilateral filter of the present invention provides a means of processing image data that may be compatible with the perception based approach compared, for example, with known approaches involving eye tracking and foveation mapping. More specifically, a characteristic of the bilateral filter may be more readily changed to take account of a change in a part of interest to a viewer from one image to another. Also, a bilateral filter can provide for the preservation of edges of features in an image that are located separately from where the viewer is directing his gaze. Also, a selective bilateral filter can provide for the preservation of edges in an image that are located where the viewer is directing his gaze, whilst preserving fine detail of features in an image that are of particular interest but are not necessarily located where the viewer is directing his gaze.

More specifically, the filtering may comprise filtering the image data such that data for the identified at least one part is of higher fidelity than data for at least one other part of the image other than the identified at least one part. In use, the filtering may be selective to provide for a variation in fidelity across the image that is in accordance with a viewer's focus of interest within the image.

Alternatively or in addition, the identified at least one part of the image may not be filtered and at least one other part of the image other than the identified at least one part may be filtered. Thus, the fidelity of the identified at least one part of an image may be preserved and the fidelity of the at least one other part of the image may be reduced.

Alternatively or in addition, the identified at least one part of the image may be filtered to a first extent and at least one other part of the image other than the identified at least one part may be filtered to a second extent, the second extent being greater than the first extent.

Alternatively or in addition, an extent of filtering of image data may progressively change from a part of the image of interest to the viewer to another part of the image.

More specifically, the extent of filtering may change progressively in accordance with a Gaussian distribution.

Alternatively or in addition, the method may comprise forming a spatial weighting map in dependence on the identified at least one part of the image, the spatial weighting map corresponding at least in part to extents of interest to a viewer of parts of an image.

More specifically, the step of filtering may be carried out in dependence on the spatial weighting map.

Alternatively or in addition, the spatial weighting map may be formed in dependence on a foveation map.

Alternatively or in addition, the spatial weighting map may be formed in dependence on a weighting function (CT), the weighting function being represented by:

$$CT ( f , e ) = {CT}_{o} exp ( α f \frac{e + {e}_{2}}{{e}_{2}} )$$

where CTo is the minimum contrast threshold of the visual system, α is the spatial frequency decay constant, e₂ is epsilon2, the half-resolution eccentricity (in degrees) at which the visual acuity is half as good as the centre of the fovea and f is the maximum spatial frequency discernible at a given retinal eccentricity e (in degrees).

Alternatively or in addition, the bilateral filter may filter image data in dependence on a predetermined range value.

More specifically, the bilateral filter may be operative not to filter image data when a difference in values of proximal image data sets, e.g. individual pixels of image data, exceeds the predetermined range value.

Alternatively or in addition, where the step of filtering is carried out in dependence on a spatial weighting map, the predetermined range value may be determined on the basis of the spatial weighting map.

More specifically, the predetermined range value for a particular pixel may be substantially equal to a corresponding weighting value contained in the spatial weighting map.

Alternatively or in addition, a predetermined range value may be modified by a scale factor, the scale factor depending on a predetermined change in fidelity of the image from a first part of the image to a second part of the image.

Alternatively or in addition, the predetermined range value may be given by:

σ_{R}(i,j)=(Map(i,j)*Scalefactor)−Scalefactcr+1

where σ_{R} is the predetermined range value, I and j are x and y coordinates of a pixel being filtered, Map is a spatial weighting map and Scalefactor is a scalefactor to be applied to the predetermined range value.

Alternatively or in addition, the method may further comprise filtering the image data in dependence on a foveation map.

Alternatively or in addition, identifying at least one part of the image may comprise identifying a location of the at least one part within the image.

Alternatively or in addition, the method may comprise identifying a plurality of parts of the image, the identified plurality of parts being of interest to the viewer.

Alternatively or in addition, the method may process a series of images to be viewed by a viewer.

More specifically, the series of images may be comprised in a video stream to be viewed by a viewer.

Alternatively or in addition, identifying at least one part of the image may comprise identifying a part of a person comprised in the image.

More specifically, identifying a part of the person may comprise identifying a face of the person.

Alternatively or in addition and where the image to be viewed is comprised in a video stream to be viewed by the viewer, the method may comprise following the at least one identified part from one image to another image.

Thus, the step of following the at least one identified part may be carried out by a tracker algorithm, such as a face tracker algorithm.

The method may be employed prior to an encoding step. Thus, alternatively or in addition, the method may further comprise a further step of encoding data filtered with the bilateral filter.

More specifically, the encoding step may comprise compression of the image data.

More specifically, the compression of the image data may comprise variable compression of image data.

According to a second aspect of the present invention, there is provided a computer program comprising executable code that upon installation on a computer causes the computer to execute the procedural steps of:
identifying at least one part of an image to be viewed by a viewer, the identified at least one part of the image being of interest to the viewer; and
filtering image data corresponding to the image with a bilateral filter, the filtering being selective in dependence on the identified at least one part of the image.

More specifically, the computer program may be embodied on at least one of: a data carrier; and read-only memory.

Alternatively or in addition, the computer program may be stored in computer memory.

Alternatively or in addition, the computer program may be carried on an electrical carrier signal.

Further embodiments of the second aspect of the present invention may further comprise one or more features of the first aspect of the invention.

According to a third aspect of the present invention, there is provided apparatus for processing image data corresponding to an image to be viewed by a viewer, the apparatus comprising:
an identifier operative to identify at least one part of the image, the identified at least one part being of interest to the viewer; and
a bilateral filter operative to filter image data corresponding to the image, the filtering being selective in dependence on the identified at least one part of the image.

Embodiments of the third aspect of the present invention may comprise one or more features of the first aspect of the present invention.

According to a fourth aspect of the present invention, there is provided a video processing apparatus comprising processing apparatus according to the third aspect of the invention, the video processing apparatus being operative to filter image data prior to encoding of the image data by a video encoder.

According to a fifth aspect of the present invention, there is provided a video encoder apparatus comprising processing apparatus according to the third aspect of the invention, the video encoder apparatus being operative to filter and encode image data.

A bilateral filter is a combination of an averaging filter and a range filter. This means that the bilateral filter operates to average differences between pixel values, such as might be caused by noise or small and thus immaterial amplitude changes, except where there is a significant change in pixel values. Where there is a significant change in pixel values there is no averaging carried out by the bilateral filter. Thus, the term bilateral filter as used herein is intended to cover other filters performing the same function.

More specifically, the bilateral filter may comprise: a spatial or spatial-temporal filter that is operative to modify at least one pixel value in an image; and a range filter (or range function) that is operative to change the operation of the filter in dependence on content of the image in a part of the image.

According to a further aspect of the present invention there is provided a method of prioritising image content for encoding comprising the steps of: identifying one or more regions of interest in the image; generating a spatial weighting map such that the one or more identified regions of interest are required to be at a first weighting; and variably filtering the image according to the spatial weighting map.

According to a yet further aspect of the present invention there is provided a video content prioritiser comprising: a region of interest identifier for identifying one or more regions of interest in the image; a spatial weighting map generator for generating a spatial weighting map such that the one or more identified regions of interest are required to be at a first weighting; and a variable filter for variably filtering the image according to the spatial weighting map.

Embodiments of the further and yet further aspects of the present invention may comprise one or more features of any previous aspect of the invention.

### SPECIFIC DESCRIPTION

The invention will now be described by way of example only and with reference to the accompanying drawings in which:

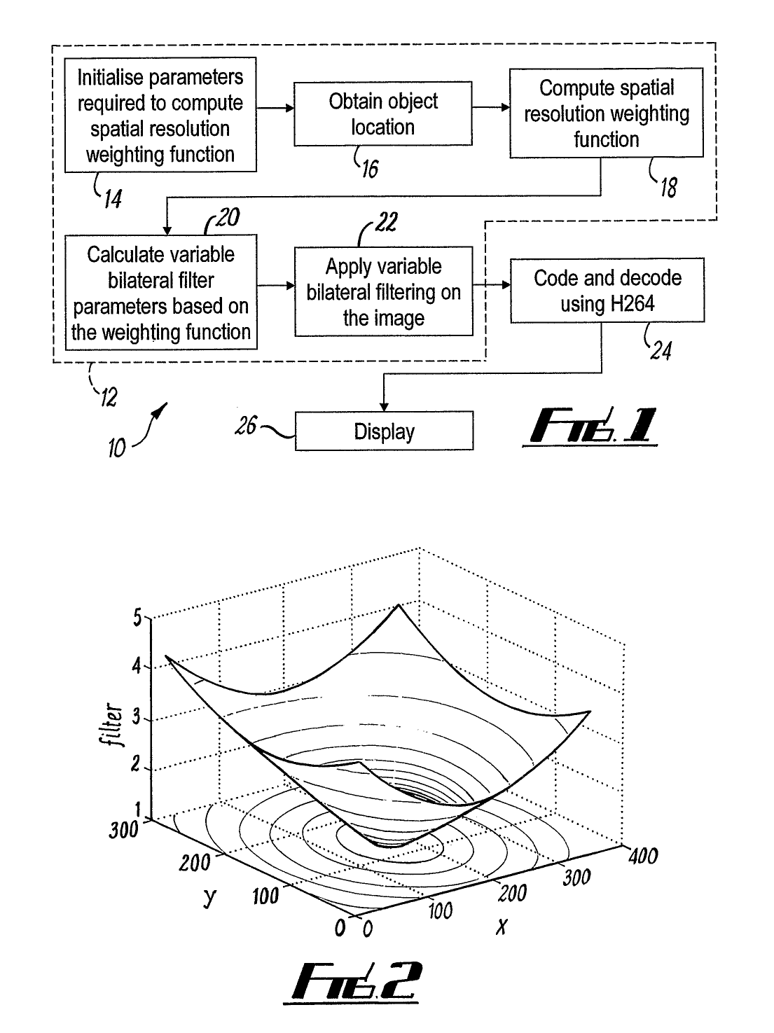

FIG. 1 shows a flow diagram of a video pre-encoding process;

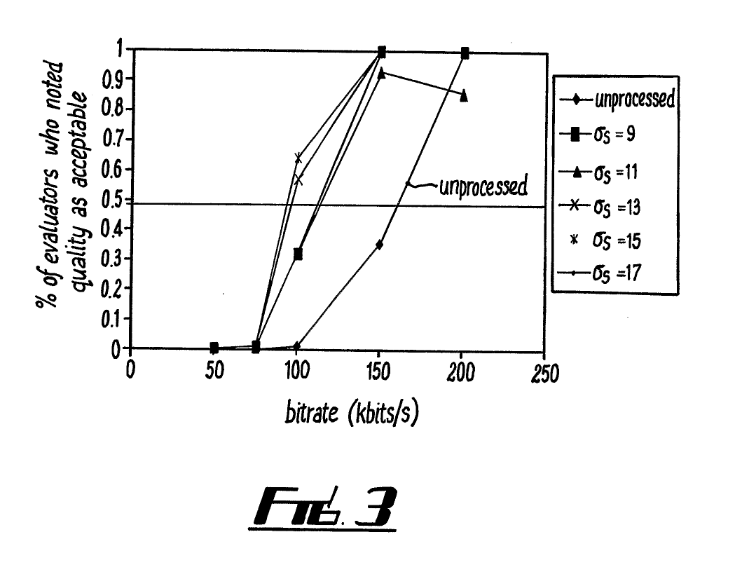

FIG. 2 shows a 3D representation of a spatial weighting map; and

FIG. 3 shows a graph of acceptable quality versus bitrate for video with varying amounts of pre-encoding according to the present invention.

The present invention relates to the problem, amongst others, that transmission bandwidth limitations require more compression to be applied than is possible through standard video encoding methods. The present invention addresses this problem by applying a spatially variant filter to the image without degrading its subjective quality. The filter maintains high fidelity around a region of interest, while reducing the image fidelity away from the point of fixation thus prioritising the resolution according to content. As parts of the image have reduced fidelity, the image can be compressed with standard video coding methods more than was possible previously and without reducing the subjective quality, thereby requiring a smaller bandwidth for the video images.

The information content of an image is reduced by filtering with a bilateral filter.

It should be noted that, in the context of the present invention, fidelity and resolution are two different concepts. Fidelity relates to the accuracy with which an image is reproduced with regard to its source. Resolution, which in this context is short for image resolution, refers to the level of detail within an image and is most often referred to in terms of the number of pixels in a particular area. A reduction in resolution for a particular area decreases the number of effective pixels in that area. Whereas, a reduction in fidelity may not alter the resolution, or at least not the resolution alone, but will instead preserve certain features in the image, such as edges, and remove others.

The bilateral filter is an edge-preserving smoothing filter. It is a combination of a Gaussian low-pass filter and a range filter. The Gaussian filter applies uniform blurring to the image regardless of the pixel intensity values. A range filter takes pixel intensity values into account by averaging pixels with similar intensities and not averaging pixels with significantly different intensities to thereby preserve the edges.

Referring to FIG. 1, a flow diagram of a video encoding system 10, including a video pre-encoder 12 according to the present invention, is shown.

The system 10 is first initialised with an initialisation process 14. The process 14 initialises the video pre-encoder 12 with required parameters to construct an appropriate spatial weighting function. These parameters are discussed in more detail in relation to the weighting function below.

The next stage involves obtaining the location of one or more objects or regions of interest. A region of interest locating process 16 applies an appropriate search algorithm to locate the region of interest. The region of interest will depend on the application of the video encoder/decoder (i.e. codec). For example, a common application is to prioritise faces in video, especially in video conferencing. In this case, the location of the face in each frame is obtained from a face tracking module.

The identification of regions of interest, such as human faces and/or human figures, in a video scene, is based on research into visual quality (e.g. Zhong, Richardson, Sahraie and McGeorge, “Influence of Task and Scene Content on Subjective Video Quality”, Lecture Notes on Computer Science, Volume 3211/2004, also Muir and Richardson, “Perception of Sign Language and its Application to Visual Communication for Deaf People”, Journal of Deaf Studies and Deaf Education 10:4, September 2005).

Based on the results of process 16, a spatial weighting map is formed using a weighting function, in a spatial weighting calculation process 18. The spatial weighting map is designed to keep the region or regions of interest at a first weighting value, representing a first quality or fidelity, and then to decrease the quality or fidelity with increasing eccentricity from the region or regions to a second quality or fidelity, represented by a second weighting value.

A variable filter calculation process 20 then processes the spatial weighting map to calculate appropriate filter parameters such that filtering of the image will be varied according to the spatial weighting map.

A variable filtering process 22 then filters the image according to the filter parameters calculated in process 20.

After the image data has been filtered according to the present invention, it is then forwarded to a standard coding system 24 and, eventually, to a display 26.

Region of Interest Identification

The present invention enables video images to be more highly compressed by taking advantage of the manner in which the human visual system analyses images. That is, where the natural tendency is to look at a particular region of interest, there is no reason to produce the other areas of the video stream in high fidelity as this is wasted on the human visual system.

As such, the present invention is applicable to a wide range of video streams where regions of interest can be identified. For example, in many movie pictures, the director is actually continually ensuring that viewers look at a particular area of the video image. Where such an area can be identified, the present invention is used to produce high fidelity where the viewers should be looking and lower fidelity elsewhere. This may enable less bandwidth to be used to, for example, stream video to mobile devices.

However, the present invention is particularly applicable in video streams where a human face is the main focus. Human faces are important areas of fixation in applications such as sign language communications, television broadcasting, surveillance, teleconferencing and videophones.

Locations of faces in each frame can be obtained by using a face tracker. Face tracking can be carried out by a number of known methods, such as an elliptical face tracker described by Birchfield et al (S. Birchfield, “Elliptical head tracking using intensity gradients and color histograms”, Proceedings of the IEEE Conference on Computer Vision and Pattern Recognition, pages 232-237, 1998).

Spatial Weighting Map

After the region or regions of interest have been identified a spatial weighting map is formed. The map is formed by assigning a weighting value to each pixel of the image according to a weighting function.

The weighting function determines which resolutions are appropriate at each point in the processed image and, in this example, is intended to match the resolution variance of the human visual system.

One such weighting function was developed by Geisler and Perry (W. S. Geisler, J. S. Perry, “A Real-Time Foveated Multi-Resolution System for Low Bandwidth Video Communication.” SPIE Proceedings Vol. 3299, 1998).

The weighting function is given in equation (1):

$$CT ( f , e ) = {CT}_{o} exp ( α f \frac{e + {e}_{2}}{{e}_{2}} ) \qquad ( 1 )$$

where, CTo is the minimum contrast threshold of the visual system, α is the spatial frequency decay constant, e₂ is epsilon2, the half-resolution eccentricity (in degrees) at which the visual acuity is half as good as the centre of the fovea (the point of best vision in the eye). f is the maximum spatial frequency discernible at a given retinal eccentricity e (in degrees). The amount of degradation in the resolution with increase in eccentricity from point of gaze is controlled by varying the minimum contrast threshold (CTₒ). Increasing the value of CTₒ increases the amount of blurring away from the point of gaze. These values have been psychophysically measured by Arnow et al (T. L. Arnow and W. S. Geisler, “Visual detection following retinal damage: Predictions of an inhomogeneous retinocortical model”, SPIE Proceedings: Human Vision and Electronic Imaging, Vol. 2674, pp. 119-130, 1996) to produce a resolution fall-off map that matches the resolution variance of the human visual system. The values used are as follows:

α−spatial frequency decay constant=0.106
Epsilon2−half-resolution eccentricity=2.3
CT₀−minimum contrast threshold= 1/64.

In this example, the spatial weighting map produced using the weighting function contains floating point values ranging between 1 and the number of fidelity levels required in the image. If 7 fidelity levels are used in the image then the values in the weighting map will range between 1 and 7. The region of fixation that has to be maintained at the highest fidelity is assigned a value of 1 in the weighting matrix. As the fidelity degrades away from the point of fixation, the values of points in the weighting matrix will increase accordingly. FIG. 2 shows a spatial weighting map generated using the weighting function described in equation (1). The x and y axes represent the two dimensional plane of an image and the “filter” axis represents the weighting value applied to that point of the image. The region of interest, in this example, is towards the centre of the image (approximately x=175 and y=125) and has a weighting value of 1. As the distance increases from the region of interest, the weighting value increases.

It should be appreciated that, where more than one region of interest is identified, the spatial weighting map has more than one minimum point. As such, the areas between regions of interest then contour appropriately to a local maximum or peak.

After the weighting map is computed, the variable filter parameters are calculated based on the map.

In this example, a bilateral filter is used (C. Tomasi and R. Manduchi, “Bilateral filtering for gray and coloured images”, Proceedings of IEEE International Conference on Computer Vision, 836-846, 1998). The bilateral filter is an edge-preserving smoothing filter which is a combination of the Gaussian blurring filter and a range filter. In an image neighbourhood that contains pixels with similar intensity values, the bilateral filter acts as a standard Gaussian blurring filter and averages small differences in pixel values caused by noise. If the neighbourhood contains a strong edge, the bilateral filter functions as a range filter to preserve the edge.

The bilateral filter equation is given by equation (2):

$$F ( {x}_{0} , {y}_{0} ) = \frac{{\sum }_{x = - N}^{N} {\sum }_{y = - N}^{N} I ( x , y ) W ( x , y )}{{\sum }_{x = - N}^{N} {\sum }_{y = - N}^{N} W ( x , y )} \qquad ( 2 )$$

where W(x,y) is the filter weighting function, I(x,y) is the input image neighbourhood pixel, and the denominator is the normalisation of the weighting function. F(x₀,y₀) is the result of the bilateral filter applied on a 2N+1 neighbourhood. The weighting function W(x,y) is defined using the Gaussian blurring function W_{S}(x,y) and the range filter function W_{R}(x,y) is defined as:

$$\begin{matrix}W ( x , y ) = {W}_{S} ( x , y ) {W}_{R} ( x , y ) \\ where & ( 3 ) \\ {W}_{S} ( x , y ) = exp \{ - \frac{( {( x - {x}_{0} )}^{2} + {( y - {y}_{0} )}^{2}}{2 {σ}_{S}^{2}} \} \\ and & ( 4 ) \\ {W}_{R} ( x , y ) = exp \{ - \frac{{( I ( x , y ) - I ( {x}_{0} , {y}_{0} ) )}^{2}}{2 {σ}_{R}^{2}} \} & ( 5 )\end{matrix}$$

Bilateral filtering of an image is controlled using the two parameters: σ_{S} and σ_{R}. σ_{S} in equation (4) is the Gaussian filter parameter that controls the amount of blurring. σ_{R} in equation (5) is the edge stopping function and defines the strengths of edges that will be preserved. When the value of σ_{R} is small, the range filtering dominates because small edges must be preserved. If a large value of σ_{R} is considered, only very strong edges are preserved. A large value of σ_{R} will have very little effect on σ_{S} and the bilateral filter acts as a standard Gaussian filter.

The standard bilateral filter described above can be used to obtain a uniform fidelity image. However, to produce a multi-fidelity image that varies in fidelity in a similar way to the response of the human visual system, a spatially variable filter must be used.

In this example, a variable bilateral filter is used. The variable bilateral filter in combination with the spatial weighting map maintains the region of fixation at highest fidelity and gradually reduces image fidelity away from the region of fixation by increasing the amount of filtering.

The parameters of the variable bilateral filter, σ_{S} and σ_{R}, are calculated based on the spatial weighting map that is obtained using the weighting function given in equation (1). The Gaussian filter parameter σ_{S} controls the amount of blurring in the image and has been assigned a constant value. The value of the edge preserving parameter σ_{R} is calculated as shown in equation (6):

σ_{R}(i,j)=Map(i,j) (6)

where, Map is the resolution map, I and j are the x- and y-coordinates of the pixel being filtered, σ_{R}(i, j) is the value of the edge preserving parameter for the pixel being filtered. According to equation (6), at the point of fixation σ_{R} will be equal to 1 and hence filtering will not be applied in this region to preserve all the edges. The maximum amount of filtering that can be applied to the peripheral regions of the image using equation (6) depends entirely on the weighting map. To further increase the amount of filtering in the peripheral regions of the image a scale factor is introduced as shown in equation (7):

σ_{R}(i,j)=Map(i,j)*Scalefactor (7)

where, Scalefactor is greater than 1 to increase filtering in the peripheral regions. However, to maintain the area of fixation (gaze) at highest resolution, σ_{R} must be equal to 1 to avoid filtering in this region. Hence the scale factor is substracted from equation (7) and a value of 1 is added as shown in equation (8):

σ_{R}(i,j)=(Map(i,j)*Scalefactor)−Scalefactor+1 (8)

After σ_{R} is calculated, bilateral filtering is applied to the image according to equation (3).

During experiments five processed video clips were produced using five different bilateral filter strengths. The bilateral filter strength was varied by varying the Gaussian filter parameter (σ_{S}). The σ_{S} values used in the experiment were: 9, 11, 13, 15 and 17. The range filter parameter σ_{R} was calculated using the spatial weighting map. A Scalefactor of 4 was used. Each processed video clip was then coded using a H264 codec for five different target bit-rates: 50 kbits/s, 75 kbits/s, 100 kbits/s, 150 kbits/s and 200 kbits/s. The coded video clips were evaluated by 14 subjects. These video clips were presented to subjects in an order of increasing bit-rates. This method of evaluation has been used successfully in previous research works (McCarthy et al, 2004). A binary scale (acceptable and non-acceptable) was used to express the judgement of the video quality of each sequence.

FIG. 3 shows a graph of percentage of evaluators who found the quality of video sequences acceptable for a range of bit-rates.

From the experimental results it was observed that more than 50% of the evaluators found the video quality of the unfiltered H264 encoded sequences to be acceptable at around 160 kbits/s. For the H264 encoded sequences that were pre-filtered according to the present invention, more than 50% of the evaluators found that video sequences filtered using σ_{S}=13, 15 and 17, had acceptable quality at 100 kbits/s. This implies that a coding gain of around 60 kbits/s can be obtained by using the variable bilateral filter when compared with the unfiltered coded video sequences. The experimental results also indicted that the optimum value of the Gaussian filter parameter is above σ_{S}=13.

As such, viewers found the pre-filtered coded video to be acceptable at significantly lower bit-rates than the unfiltered coded video.

Prior work on object, or video content, based coding has led to standardised techniques for compressing regions of a video scene (e.g. ISO/IEC 14496 Part 2, “MPEG-4 Visual”, 2001, Core Profiles). However, these typically require specialised coding tools that are incompatible with popular block-based video coding methods (e.g. MPEG-4 Visual, Simple and Advanced Simple profiles).

The present invention can be used with any video compression system such as a standard block-based video codec. As a result, specialised object, or video content, based coding tools are not required.

Improvements and modifications to the present invention may be incorporated in the foregoing without departing from the scope of the present invention as defined herein.

1. A method of processing image data corresponding to an image to be viewed by a viewer, the method comprising:
identifying at least one part of the image, the identified at least one part being of interest to the viewer; and
filtering the image data with a bilateral filter, the filtering being selective in dependence on the identified at least one part of the image.

2. A method according to claim 1, in which the filtering comprises filtering the image data such that data for the identified at least one part is of higher fidelity than data for at least one other part of the image other than the identified at least one part.

3. A method according to claim 1 or 2, in which the identified at least one part of the image is not filtered and at least one other part of the image other than the identified at least one part is filtered.

4. A method according to any preceding claim, in which the identified at least one part of the image is filtered to a first extent and at least one other part of the image other than the identified at least one part is filtered to a second extent, the second extent being greater than the first extent.

5. A method according to any preceding claim, in which an extent of filtering of image data changes progressively from a part of the image of interest to the viewer to another part of the image.

6. A method according to claim 5, in which the extent of filtering changes progressively in accordance with a Gaussian distribution.

7. A method according to any preceding claim, in which the method comprises forming a spatial weighting map in dependence on the identified at least one part of the image, the spatial weighting map corresponding at least in part to extents of interest to a viewer of parts of an image.

8. A method according to claim 7, in which the step of filtering is carried out in dependence on the spatial weighting map.

9. A method according to claim 7 or 8, in which the spatial weighting map is formed in dependence on a foveation map.

10. A method according to any of claims 7 to 9, in which the spatial weighting map is formed in dependence on a weighting function (CT), the weighting function being represented by:
$$CT ( f , e ) = {CT}_{o} exp ( α f \frac{e + {e}_{2}}{{e}_{2}} )$$
where CTo is a minimum contrast threshold of the visual system, α is a spatial frequency decay constant, e₂ is epsilon2, a half-resolution eccentricity, in degrees, at which visual acuity is half as good as the centre of the fovea and f is a maximum spatial frequency discernible at a given retinal eccentricity e, in degrees.

11. A method according to any preceding claim, in which the bilateral filter filters image data in dependence on a predetermined range value.

12. A method according to claim 11, in which the bilateral filter is operative not to filter image data when a difference in values of proximal image data sets exceeds the predetermined range value.

13. A method according to claim 11 or 12, where the step of filtering is carried out in dependence on a spatial weighting map, in which the predetermined range value is determined on the basis of the spatial weighting map.

14. A method according to claim 13, in which the predetermined range value for a particular pixel is substantially equal to a corresponding weighting value contained in the spatial weighting map.

15. A method according to any of claims 11 to 14, in which the predetermined range value is modified by a scale factor, the scale factor depending on a predetermined change in fidelity of the image from a first part of the image to a second part of the image.

16. A method according to any of claims 11 to 15, in which the predetermined range value is given by
σ_{R}(i,j)=(Map(i,j)*Scalefactor)−Scalefactor+1
where σ_{R} is a predetermined range value, I and j are x and y coordinates of a pixel being filtered, Map is a spatial weighting map and Scalefactor is a scalefactor to be applied to the predetermined range value.

17. A method according to any preceding claim, in which the method further comprises filtering the image data in dependence on a foveation map.

18. A method according to any preceding claim, in which the method comprises identifying a plurality of parts of the image, the identified plurality of parts being of interest to the viewer.

19. A method according to any preceding claim, in which the method processes a series of images to be viewed by a viewer.

20. A method according to claim 19, in which the series of images is comprised in a video stream to be viewed by a viewer.

21. A method according to any preceding claim, in which identifying at least one part of the image comprises identifying a part of a person comprised in the image.

22. A method according to claim 21, in which identifying a part of the person comprises identifying a face of the person.

23. A method according to any preceding claim and where the image to be viewed is comprised in a video stream to be viewed by the viewer, the method comprises following the at least one identified part from one image to another image.

24. A method according to claim 23, in which the step of following the at least one identified part is carried out by a tracker algorithm.

25. A method according to claim 24, in which the tracker algorithm comprises a face tracker algorithm.

26. A method according to any preceding claim further comprising a step of encoding data filtered with the bilateral filter.

27. A method according to claim 26, in which the encoding step comprises compression of the image data.

28. A method according to claim 27, in which the compression of the image data comprises variable compression of image data.

29. A computer program comprising executable code that upon installation on a computer causes the computer to execute the procedural steps of:
identifying at least one part of an image to be viewed by a viewer, the identified at least one part of the image being of interest to the viewer; and
filtering image data corresponding to the image with a bilateral filter, the filtering being selective in dependence on the identified at least one part of the image.

30. A computer program according to claim 29, in which the computer program is embodied on at least one of: a data carrier; and read-only memory.

31. A computer program according to claim 29 or 30, in which the computer program is stored in computer memory.

32. A computer program according to any one of claims 29 to 31, in which the computer program is carried on an electrical carrier signal.

33. Apparatus for processing image data corresponding to an image to be viewed by a viewer, the apparatus comprising:
an identifier operative to identify at least one part of the image, the identified at least one part being of interest to the viewer; and
a bilateral filter operative to filter image data corresponding to the image, the filtering being selective in dependence on the identified at least one part of the image.

34. Video processing apparatus comprising processing apparatus according to claim 33, the video processing apparatus being operative to filter image data prior to encoding of the image data by a video encoder.

35. Video encoder apparatus comprising processing apparatus according to claim 33, the video encoder apparatus being operative to filter and encode image data.
